(19) United States
(12) Patent Application Publication
(10) Pub. No.: US 2008/0256337 A1
(43) Pub. Date: Oct. 16, 2008

(54) Method of Decoding A Bit Sequence, Network Element Apparatus And PDU Specification Tool Kit

(75) Inventors: Kevin Mitchell, Innerleithen (GB); Tony Kirkham, Edinburgh (GB)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/102,058

(22) Filed: Apr. 14, 2008

(30) Foreign Application Priority Data
Apr. 14, 2007 (GB) GB0707215.0

(51) Int. Cl. G06F 9/30; G06F 9/312; G06F 9/44

(52) U.S. Cl. 712/208; 712/214; 717/140; 712/E09.033; 712/E09.028

(57) ABSTRACT

In the field of data communications, it is desirable to track bits of a bit sequence remaining to be decoded by a decoder. A method of decoding the bit sequence that corresponds to a PDU comprises reading-in a bit sequence and processing the bit sequence. In order to maintain a record of the bits reaming to be processed, a data stack is used during decoding of the bit sequence.

The present invention relates to a method of decoding a bit sequence of the type that, for example, comprises decoding of a bit sequence that corresponds to a Protocol Data Unit having a field that is constrained. The present invention also relates to a network element apparatus of the type that, for example, comprises a decoder for decoding a bit sequence that corresponds to a Protocol Data Unit having a field that is constrained. The present invention further relates to a Protocol Data Unit specification toolkit that comprises a compiler that is arranged to compile code written in an implementation language into object code for execution by a network element apparatus.

In the field of data communications, communications protocols support the exchange of Protocol Data Units (PDUs) between network elements within a communications network. A given PDU can contain fields of varying lengths, particularly when compact encodings are required for reasons of efficiency, or where the nature of the data being transmitted does not naturally result in fixed and small upper bounds to be imposed upon a size of a given field. Therefore, one strategy employed in many communications protocols is a so-called Type/Length/Value (TLV) approach to describe sub-fields. Use of the TLV approach enables a length of a PDU to be determined without having to traverse the complete PDU when decoding.

One known technique to describe one or more types in a PDU or nested PDUs is to employ a packet specification language. One such language is known as PacketTypes, as described in: “PacketTypes: Abstract Specification of Network Protocol Messages” (P J McCann, S Chandra, Proceedings of ACM SIGCOMM, 2000).

When decoding a bit sequence corresponding to a PDU, it is desirable to track the length of the PDU and the number of bits in the bit sequence remaining to be processed. In the case of decoding a single type, for example as shown below (expressed using packet type specification language pseudo-code), called “Trip_Message”, it can be seen that the length of the field “payload” can be determined easily prior to commencement of decoding of this field.

| Trip_Message = | |
|---|---|
| length: | UInt 16 |
| type: | Trip_Message_Type |
| payload: | Trip_Payload<type> |
| | where numBytes = (length − 3) |

However, for more complex structures, for example, an IPv4 PDU as shown below, multiple size constraints, sometimes nested, exist.

| | |
|---|---|
| IPv4 = | |
| ( header: ( ... | |
| ihl: | UInt 4 |
| ... | |
| totallength: | UInt 16 |
| ... | |
| protocol: | UInt 8 |
| ... | |

```
        ) where numBytes = ihl
    payload: IP_Payload <header.protocol>
) where numBytes = header.totallength;
```

The above structure comprises sub-structures. Each sub-structure can be perceived in a context of a constraint upon the sub-structure, for example length or size. Hence, reference will be made herein to the structure of the PDU comprising one or more context, contexts sometimes being nested.

From the above example of the IPv4 PDU, it can be seen that there exists a notion of “bits remaining” to be decoded, which has to be interpreted in a relative context, i.e. the length of one field may be dependent upon a value stored in another field.

In some scenarios, an overall length of a PDU is known prior to commencement of a decoding process, for example when the PDU is being read from a dump file or a buffer provided by an interface card of a network element, such as a network monitoring apparatus. However, in some situations, the overall length of the PDU is not known in advance, for example when a packet decoder is running in firmware “consuming” bits as they arrive “off the wire”. In such situations, the actual overall length of the PDU is not typically known until a terminator of some form is encountered at the end of the bit sequence.

It is therefore necessary to distinguish between logical and physical size constraints, because knowledge (at a logical level) that bits remain to be read does not always mean that (at a physical level) these bits exist to be read. A primary reason for such divergence between logical and physical lengths is errors, for example a PDU can be improperly generated or corrupted due to transmission errors.

One possible technique to monitor sizes of fields of a PDU requires separate counters to be provided and updated as the packet decoder obtains more information concerning the length of one or more fields of the PDU. However, such a technique requires all counters affected to be updated and this approach constitutes a significant processing overhead to be avoided, especially where multiple contexts are nested.

### SUMMARY

According to a first aspect of the present invention, there is provided a method of decoding a bit sequence, the method comprising: reading-in the bit sequence corresponding to a PDU; processing the bit sequence; during the processing of the bit sequence, using a data stack to maintain a record of a quantity of bits remaining to be processed.

Processing the bit sequence may comprise decoding the bit sequence. The PDU may conform to a predefined data type definition, the bit sequence being decoded in accordance with the predefined data type definition.

The PDU may comprise a first field having a first length defined by the data type definition.

The PDU may comprise a second field having a second length defined by the data type definition. The second field may be disposed within the first field.

The first length of the first field may be dependent upon the second length of the second field.

The bit sequence may be read-in serially.

The method may further comprise: decoding a number of bits of the bit sequence to obtain size constraint data; and manipulating the data stack in response to obtaining the size constraint data.

The data stack may be manipulated with respect of a topmost entry thereof. The topmost entry of the data stack is manipulated to the exclusion of other entries in the data stack below the topmost entry.

The data stack may comprise a first entry corresponding to the first field. The data stack may comprise a second entry corresponding to the second field. The second entry may be located lower than the first entry in the data stack.

Relative positions in the data stack may signify relative positions of fields in the PDU.

The method may further comprise: initially providing the data stack with a data entry prior to use of the data stack to maintain the record of the quantity of bits remaining to be processed.

The method may further comprise manipulating the data stack by execution of an operation in relation to the data stack.

The operation may be provided as part of a library of operations.

The operation may be arranged to modify the topmost entry of the data stack.

The operation may be arranged to add the additional entry to a top of the data stack.

The operation may be arranged to remove the topmost entry from the data stack.

Manipulation of the data stack may have a side-condition associated therewith, breach of the side-condition being indicative of an error and/or fault.

According to a second aspect of the present invention, there is provided a network element apparatus comprising: an input for reading-in, when in use, a bit sequence corresponding to a PDU; a decoder unit coupled to the input, the decoder unit being arranged to process the bit sequence; wherein the decoder unit is further arranged to use during the processing of the bit sequence, a data stack to maintain a record of a quantity of bits remaining to be processed.

According to a third aspect of the present invention, there is provided a PDU specification language toolkit comprising: a library of operations in order to maintain a data stack having a data entry relating to a constraint of a field for a PDU; a compiler arranged to use the library of operations in order to compile, when in use, code expressed in an implementation language into object code constituting a PDU decoder for execution by a network element; wherein an operation of the library of operations is executable, when in use, so as to manipulate the data stack during decoding of a bit sequence in order to maintain a record of a quantity of bits of the bit sequence remaining to be processed.

The operation may be arranged to add a data entry to the data stack.

The operation may be arranged to remove a data entry from the data stack.

The operation may be arranged to modify a data entry of the data stack.

According to a fourth aspect of the present invention, there is provided a computer program element comprising computer program code means to make a computer execute the method as set forth above in relation to the first aspect of the present invention.

The computer program element may be embodied on a computer readable medium.

It is thus possible to provide a method, apparatus and toolkit that enables sizes of fields to be tracked during a PDU decoding process. The fields are tracked in an efficient manner, as a result of operating on a topmost entry of the stack to the exclusion of entries below the topmost entry, resulting in minimal coding and processing overhead. Further, field over-runs and under-runs are identified in a timely manner in the PDU decoding process.

At least one embodiment of the invention will now be described, by way of example only, with reference to the accompanying drawings, in which:

### BRIEF DESCRIPTION OF THE DRAWINGS

FIG. 1 is a schematic diagram of a compilation process constituting an embodiment of the invention;

FIG. 2 is a schematic diagram of a stack;

FIG. 3 is a flow diagram of a method of generating object code associated with the embodiment of FIG. 1;

FIG. 4 is a schematic diagram of a network element apparatus constituting another embodiment of the invention; and

FIG. 5 is a schematic diagram of a bit sequence; the data shown is arbitrary and does not constitute real data communicated in a communication network.

### DETAILED DESCRIPTION

Throughout the following description identical reference numerals will be used to identify like parts.

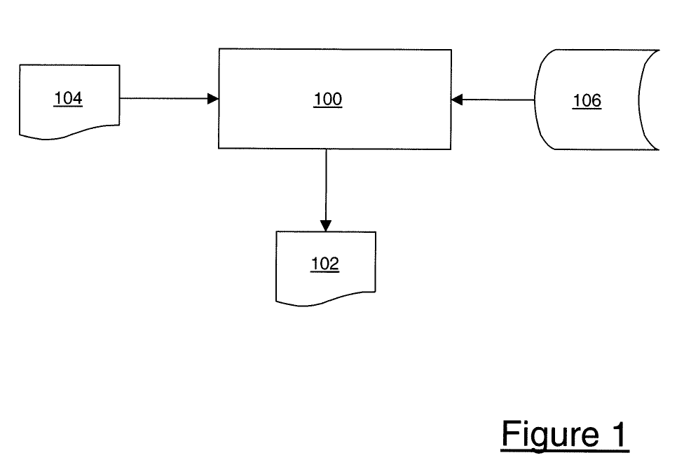

Referring to FIG. 1, a packet decoding process can be generated in a number of ways, as is known in the art. The packet decoding process can be generated so as to be in the form of a set of instructions executable by a pre-written virtual machine, or machine executable code. In the present example, the latter implementation is employed, though the former implementation is equally applicable.

In order to generate the machine executable code 102 executable by a network element (not shown in FIG. 1) to implement the packet decoding process, a compiler 100 is employed. The compiler 100 is a dedicated compiler created to generate packet decoding processes and use an input data file 104 containing specifications of packets written in a packet specification language, for example PacketTypes.

In addition to standard, for example C++, libraries, the second compiler 106 also uses a stack tracking library 106 when generating the machine executable code 102, the stack tracking library 106 comprising code implementing a set of operations to support a stack (not shown in FIG. 1) for tracking sizes/lengths of packets being decoded by the packet decoder process. In order to achieve support for the stack, the compiler 100 incorporates into the machine executable code 102 code implementing one or more operation from the set of operations. The operations serve to add entries to the top of the stack, remove entries from the top of the stack and modify topmost entries of the stack. The calls are incorporated into the machine executable code 102 of the decoder process in order to manipulate the stack following, or in response to, certain stages in the decoding of a packet, for example upon definition of a context or processing of bits. The relative positions of entries in the data stack reflect relative positions of contexts and hence fields in the packet. The skilled person will, of course, understand how to write the compiler 100 and the stack tracking library 106 and so details of these activities will not be described further herein. Examples of incorporation of the calls to the one or more operation into the machine executable code 102 will be described in greater detail later herein.

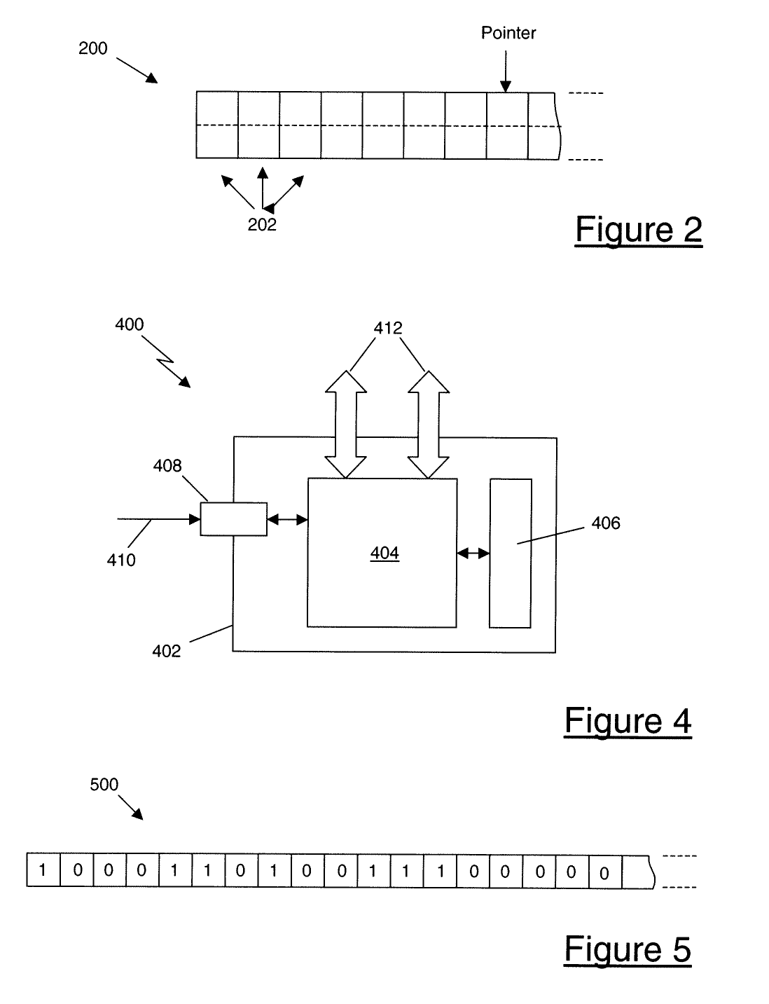

Referring to FIG. 2, the stack 200 comprises a plurality of data entries or elements 202. The plurality of data entries constitutes a sequential list of pairs of natural numbers, N. To express operations in relation to the stack 200, the following notation is employed.
s is a set of stacks
σ ranges over elements of stacks in the set of stacks, s
ε: s is an empty stack
• is a constructor defined as: (n×n)×s→s to express a stack in terms of a topmost entry of the stack and the remaining elements of the stack

In general, the stack 200 has the form:
pₙ·(pₙ₋₁·( . . . (p₁·ε . . . ))
   where:

n is the size of the stack 200, n≧0

p is an entry of the stack 200

pₙ is the topmost entry of the stack 200

The stack 200 can also be expressed in the form:
<pₙ, pₙ₋₁, . . . , p₁>

Using the above notation, the operations of the set of operations for a given stack described above are defined as follows:

consume: n×s→s
consume (n,(r,m)·σ)=(r−n,m)·σiff n≦r

new: s→s
new ((r,m)·σ)=(r,r)·(r,m)·σ

set: n×s→s
set (n,(r,m)·σ)=(n+r−m,n)·σiff m−r≦n≦m

push: n×s♯s
push (n,(r,m)·σ)=(n,n)·(r,m)·σiff n≦r

pop: s→s
pop ((r,m)·(r′,m′)·σ)=(r′−m+r,m′)·σ

popz: s→s
popz ((0,m)·(r′,m′)·σ)=(r′−m,m′)·σ

In the above definitions, a topmost stack entry is denoted by (r,m), where a set or push operation has been executed, has a first entry ‘r’ representing the number of bits remaining in a current context and a second entry ‘m’ representing the number of bits remaining in the current context. However, when a new operation has been executed but before the set operation has been executed, it should be noted that the values of the first and second entries r, m are upper bounds on the true values that these entries should represent.

The consume operation operates on the topmost entry of the stack, in particular a record of the number of bits to be processed remaining, ‘r’, and reduces the count of bits remaining by ‘n’, i.e. to yield r−n. The new operation simply adds an entry to the top of the stack when a new context is established. The pop operation is used to remove an entry from the top of the stack, ensuring that the remainder count of the newly exposed topmost entry is updated to take into account a current remainder count of the entry removed from the stack. The popz operation is a special case of the pop operation for specific known situations where a remainder is expected to be 0 at an end of a context.

Additionally, performance of certain operations is a specific order results in the following equivalences:
new; set (n)≡push (n)
push (n); consume (n); pop ( )≡consume (n)

Incorporation of operations from the above-described operations into the machine executable code 102 by the first compiler 100 will now be described in the context of examples of different definitions of types for PDUs. For the sake of consistency, the types are expressed in the packet specification language pseudo-code used previously herein, though the skilled person will appreciate that any suitable packet specification language can be employed.

In a first example, a first PDU type, T1, is defined as follows:
T1=a: T
   (b: Bit [ ]) where numBits=a;
      where T is a type. Other than noting that the type, T, is an arbitrary type defined elsewhere in the input data file 104 with a value of type integer, the nature of the type is unimportant for the sake of this example and so will not be described in further detail herein.

As can be seen from the example of the first PDU type, T1, defined above, the size of the context is defined before commencement of the context (defined in parenthesis). In order to support the stack 200 in relation to the first PDU type, T1, the following stack support calls are embedded into code of the decoder process used to decode PDUs received.

Code Fragment I

“code for a”;
new;
set (value (a));
“code for b”;
popz

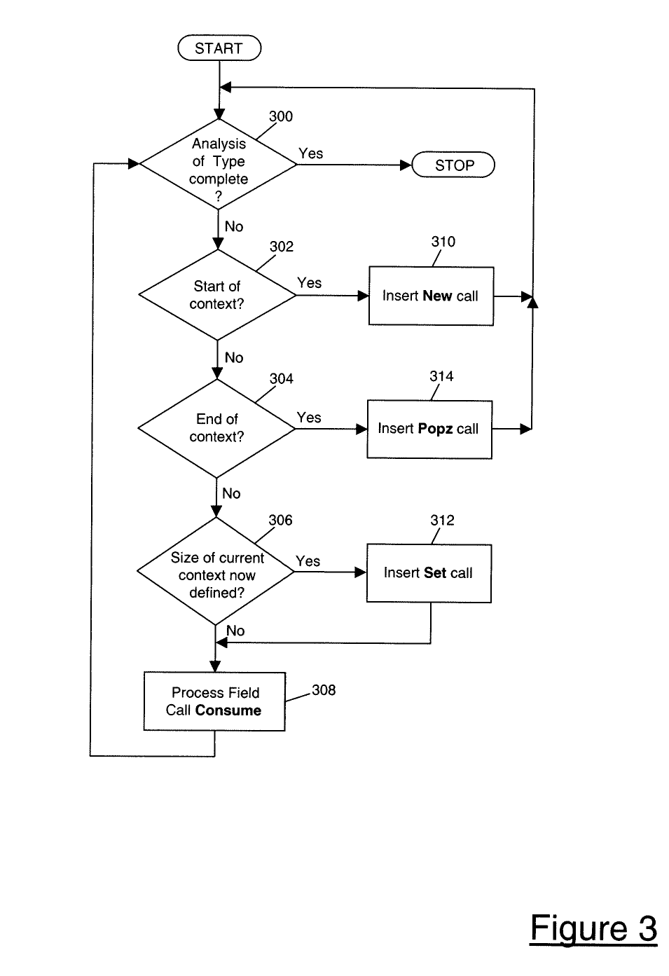

Although not shown for the sake of conciseness of description, code fragment I also includes calls to the consume operation, which will be mentioned later herein. Referring to FIG. 3, the pseudo-code of code fragment I above is achieved as follows.

The compiler 100 assesses whether analysis of the first PDU type, T1, has been completed (Step 300). Since analysis of the first PDU type, T1, has only just commenced, the compiler 100 proceeds to traverse the first PDU type, T1, as defined in the input data file 104, analysing the syntax of the first PDU type, T1, until the first field, ‘a’, is encountered. The compiler 100 establishes that the presence of the first field relates to a context (Step 302), but for the sake of simplicity of description, as the type, T, is defined elsewhere, processing of the context of the first field, ‘a’ by the compiler 100 will not be described further herein. Consequently, in this example, it will suffice to state that the compiler 100 generates the code to decode the first field (“code for a”) along with a call to the consume operation (not shown) defined above (Step 308).

Thereafter, the compiler 100 returns to assessing whether the analysis of the first PDU type, T1, has been completed (Step 300). As analysis of the first PDU type, T1, is still in progress as part of the first PDU type, T1, remains to be analysed, the first compiler 102 continues to traverse the first PDU type, T1, whereupon the syntactic analysis performed by the first compiler 102 establishes that the beginning of a context has been encountered (Step 302) by virtue of a constraint expressed in the definition of the first PDU type, T1 (the ‘where’ expression). Consequently, the compiler 100 firstly inserts a call to the new operation (Step 310) after the code to decode the first field, ‘a’. The compiler 100 then re-assesses whether the analysis of the first PDU type, T1, has been completed (Step 300).

Since analysis of the context encountered is in progress, the first compiler 102, after establishing (Step 302) that the beginning of the context has not been encountered (it was encountered in the previous iteration) and the end of the context has not yet been encountered (Step 304), the compiler 100 proceeds to determine whether the size of the context is now defined (Step 306). As the expression for the size of the context has been encountered (the ‘where’ expression) and the value of the first field, ‘a’, is known, the size of the current context is deemed defined and so the compiler 100 inserts a call to the set operation (Step 312). Thereafter, the compiler 100 treats a second field, ‘b’, relating to the context in a usual manner for a field of this type and generates the code to decode the second field (“code for b”) along with a call to the consume operation (not shown) (Step 308).

Once again, the compiler 100 then re-assesses whether the analysis of the first PDU type, T1, has been completed (Step 300). However, the compiler 100 has not yet assessed whether the end of the context has been reached, and so the compiler 100 continues processing the first PDU type, T1, recognising that the beginning of a new context has not been encountered (Step 302). However, since the size of the current context has been defined, the end of the current context is considered by the compiler 100 to have been reached (Step 304). The compiler 100 therefore then inserts a call to the popz operation (Step 314) after the code to decode the second field, ‘b’. The first compiler 300 then finally establishes that analysis of the first PDU type, T1, has been completed and processing of the first PDU type, T1, ceases.

In a second example, a second PDU type, P2, is defined for the PDUs to be decoded by the decoder process as:
T2=(a:T
   b: Bit [ ]) where numBits=a;

Here, the size of the context (set out in parenthesis above) is defined within the context itself. In order to support the stack 200 in relation to the second PDU type, T2, the following stack support calls are embedded into the code of the decoder process used to decode PDUs received.

Code Fragment II

new;
“code for a”;
set (value (a));
“code for b”;
popz;

Referring again to FIG. 3, the pseudo-code of code fragment II above is achieved as follows.

The compiler 100 firstly assesses whether analysis of the second PDU type, T2, has been completed (Step 300). Since analysis of the second PDU type, T2, has only just commenced, the compiler 100 proceeds to traverse the second PDU type, T2, as defined in the input data file 104 analysing the syntax of the second PDU, T2. The compiler 100 encounters the ‘where’ expression in the definition of the second PDU type, T2, signifying that a context is being defined and hence has been encountered. Consequently, a call to the new operation is inserted as part of the machine executable code 102, followed by code relating to decoding a first sub-field, ‘a’ (“code for a”). In this respect, the comments set out above in the previous example relating to the processing of the type, T, apply to the first sub-field ‘a’ as well. The compiler 100 then returns to determining (Step 300) whether analysis of the second PDU type, T2, has been completed. However, as other fields remain to be analysed within the parenthesis of the definition of the second PDU type, T2, constrained, the compiler 100 proceeds to establish (Step 304) whether all expressions in the context being constrained have been processed, i.e. whether the end of the present context has been reached (Step 302). As an expression in the context is yet to be processed by the compiler 100, the compiler 100 proceeds to establish (Step 306) whether the size of the context has been defined. As the size of the context is defined by the “where numBits=a” statement and the value of ‘a’ is known, the compiler 100 inserts a call to the set operation followed by code relating to the decoding of the second sub-field, ‘b’ (“code for b”). Although not shown in code fragment II above, the compiler 100 then also inserts a call to the consume operation (Step 308).

Thereafter, the compiler 100 once again establishes whether analysis of the second PDU type, T2, is complete (Step 300). Since the compiler 100 has not yet assessed whether the end of the context has been reached, the compiler 100 knows that the beginning of another new context has not been encountered (Step 302). However, now that the size of the present context has been defined and the second sub-field, ‘b’ has been processed, the compiler 100 now ascertains that the end of the context has been encountered (Step 304) and so the compiler 100 inserts a call to the popz operation (Step 314), whereafter the compiler 100 establishes that analysis of the second PDU type, T2, is complete and provision of stack support calls to support the stack 200 is therefore complete.

In a third example, a third PDU type, T3, is defined for the PDUs to be decoded by the decoder process as:
T3=(h: (x: T1
   y: T2
   z: Bit [ ]) where numBits=y
b: Bit [ ]) where numBits=h.x;

The third PDU type, T3, defines a more complex context structure than in the previous two examples, namely a first context containing a second context. The first context contains a first field, ‘h’, and a second field, ‘b’. The second context, within the first context, contains a first sub-field, ‘x’, a second sub-field, ‘y’, and a third sub-field, ‘z’, defined as sub-fields of the first field, ‘h’.

In order to support the stack 200 in relation to the third PDU type, T3, the following stack support calls are embedded into the code of the decoder process used to decode PDUs received.

Code Fragment III

new;
new;
“code for x”;
“code for y”;
set (value (y));
“code for z”;
popz;
set (value (x));
“code for b”
popz;

Referring again to FIG. 3, this pseudo-code of code fragment III above is achieved as follows.

Initially, the compiler 100 assesses whether analysis of the third PDU type, T3, has been completed (Step 300). Since analysis of the third PDU type, T3, has only just commenced, the compiler 100 proceeds to traverse the definition of the third PDU type, T3, as set out in the input data file 104, and analyses the syntax of the third PDU type, T3. Due to the presence of the ‘where’ expression following the first and second fields, ‘h’, ‘b’ contained within parenthesis, the compiler 100 establishes (Step 302) that the first context is being defined. Consequently, the compiler 100 inserts (Step 310) a call to the new operation. The compiler 100 then returns to assessing whether analysis of the third PDU type, T3, has been completed (Step 300). As analysis of the third PDU type, T3, is in progress, the compiler 100 continues to analyse the third PDU type, T3. Since the second context is embedded within the first context, as indicated by the presence of another ‘where’ expression following the first, second and third sub-fields, ‘x’, ‘y’, ‘z’ contained within parenthesis, the compiler 100 includes (Step 302) another call to the new operation (Step 310) in the machine executable code 102. Thereafter, as analysis of the third PDU type, T3, is incomplete (Step 300) and the beginnings of no more new contexts are identified (Step 302), the compiler 100 proceeds to process the definitions of the second context relating to the first field ‘h’. In this respect, the compiler 100 has clearly not finished processing the second context (Step 304) and has also not yet ascertained the size of the current context (Step 306).

As the size of the second context has not yet been ascertained, the compiler 100 inserts code for decoding the first sub-field, ‘x’, of the second context (“code for x”) and (although not shown) also inserts a call to the consume operation (Step 308). The above steps are then repeated as the end of a context has still not yet been reached in the analysis of the third PDU type, T3, resulting in the compiler 100 also inserting code for decoding the second sub-field, ‘y’ (“code for y”), followed by another call to the consume operation (Step 308). The compiler 100 then proceeds to establish, once more, whether the analysis of the third PDU type, T3, has been completed (Step 300), but of course analysis is still in progress and so processing continues.

Next, the compiler 100 therefore continues to traverse the definition of the third PDU type, T3. Whilst the start or end of new contexts are not ascertained (Steps 302, 304), the compiler 100 next processes the ‘where’ expressions of the third PDU type, T3, that constrains the second context. As the second sub-field, ‘y’, has already been encountered, the size of the second context is considered defined by virtue of the “numBits=y” statement. The size of the current (second) context is therefore now defined (Step 306) and the compiler 100 inserts a call to the set operation (Step 312). The compiler 100 then incorporates (Step 308) code to decode the third sub-field, ‘z’, (“code for z”) of the second context followed by a call to the consume operation (not shown). Thereafter, as the analysis process in relation to the third PDU type, T3, is incomplete (Step 300), but the second context has been processed and so the end of the second context is deemed to have been reached (Step 304), the complier 100 adds a call to the popz operation (Step 314).

Once decoding of the second context has been completed, the compiler 100 checks whether or not processing of the third PDU type, T3, is complete (Step 300). However, the compiler 100 continues processing the definition of the third PDU type, T3, because the compiler 100 still has to complete processing of the first context. Consequently, the beginning of a new context or the end of an existing context is not encountered (Steps 302, 304). The compiler 100 continues to process the first context of the third PDU type, T3, constrained by statement: “where numBits=h.x”. The size of the first context is deemed defined (Step 306) as the first sub-field, ‘x’, has already been encountered. Consequently, the compiler 100 incorporates (Step 312) a call to the set operation. The compiler 100 then inserts (Step 308) code to decode the remaining field, ‘b’, (“code for b”) as well as a call to the consume operation (not shown). The compiler 100 then establishes that analysis of the third PDU type, T3, is still incomplete (Step 300), as the compiler 100 has not yet ascertained that processing of the first context has been completed. However, the compiler 100 then proceeds to ascertain that the first context has been processed and hence the end of the first context is deemed to have been reached (Steps 302, 304). The compiler 100 therefore inserts a call to the popz operation (Step 314). Thereafter, the compiler 100 determines (Step 300) that analysis of the third PDU type, T3, is complete and provision of stack support calls to support the stack 200 is therefore complete.

Whilst the consume operations have been provided after code to decode fields in this and previous code fragments, the position of the call to the consume operation can be further up (earlier in) an instruction sequence provided the consume operation is not positioned so as effectively to move past an instruction that operates on the stack 200. Consequently, it may be possible to combine adjacent consume operations, i.e. consume (n₁)+consume (n₂)≡consume (n₁+n₂), thereby reducing the amount of code required.

As shown by the above examples, the packet decoder process in the form of the machine executable code 102 contains calls to operations of the type described above in order to maintain the stack 200. In this example, the packet decoder process is used in a network element, for example a network monitoring unit 400 (FIG. 4). The network monitoring unit 400 comprises a general-purpose computing apparatus, for example, a suitably specified Personal Computer (PC) 402. The PC 402 comprises a processing resource 404, for example a microprocessor, coupled to a storage device 406, for example a volatile memory, such as Random Access Memory (RAM).

The processing resource 404 is coupled to an interface card 408, the interface card being coupled to a communications link 410. The processing resource 404 is also coupled to further input/output devices, for example a display device and a keyboard (not shown) via suitable input and output interfaces 412. The processing resource 404 supports the packet decoder process as well as other applications use, in this example, for monitoring performance of a communications network (not shown).

In operation, data received as electronic signals via the communications link 410 are converted to digital input signals by the interface card 408. The conversion by the interface card 408 results in a bit sequence 500 (FIG. 4) that is read-in by the packet decoder process supported by the processing resource 404.

At least part of the bit sequence 500 is assumed to conform to a data structure definition associated with a communications protocol used in the network. The data structure definition defines, in this example, the structure of a packet including fields and sub-fields that the packet contains.

As mentioned above, at least part of the bit sequence 500 corresponds to a packet. For the sake of simplicity of description and hence clarity, the bit sequence 500 will be described in the context of PDUs that conform to the first, second and third PDU types, T1, T2, T3, described above instead of the more complex IPv4 or IPv6 packets. Nevertheless, the skilled person will appreciate that other PDUs, having more complex structures than those described hereinbelow, can be decoded whilst employing the concepts described herein to track their respective lengths.

The bit sequence 500 constitutes a first packet, P1, formed to conform with the first PDU type, T1, the packet decoder process creates an initial stack 200. The bit sequence 500 is buffered by the interface card 408 and then passed to the processing resource 404 and so the length of the first packet, P1, is known. The initial stack 200 is formed with an initial entry specifying an overall length of n bits and, as no bits of the bit sequence 500 have been decoded yet, n remaining bits:
<(n, n)>
   where n is the known length of the first packet, P1, in bits. The first parameter of the initial stack represents the number of remaining bits and the second parameter represents the overall length. Turning to code fragment I set out above in relation to the output of the compiler 100 corresponds to the machine executable code 102. However, for the sake of simplicity of description, execution of the machine executable code 102 will be described in the context of the code fragment I.

After generating the stack 200, the decoder process then starts decoding the first field, ‘a’, of the first packet, P1, after reading in bits from the bit sequence 500 corresponding to the first field, ‘a’. Once decoded, the decoder process executes the call to the consume operation (not shown) in order to reduce the record of the length of the number of bits to be decoded (remaining bits) by the length of the decoded first field, ‘a’:
<(n−nₛ, n)>
   where aₛ is the length/size of the first field, ‘a’.

The new operation is then called as the first context follows the first field, ‘a’, resulting in a new entry being added to the top of the stack 200, the updated stack having the following form:
<(n−aₛ, n) (n−aₛ, n)>

As the value of the first field is expected to be known as a result of decoding of the first field, ‘a’, code fragment I contains the call to the set operation, which is therefore executed. This results in the topmost entry of the stack 200 being updated to:
<(a, n) (n−aₛ, n)>

Following an update of the topmost entry of the stack 200, the decoder process decodes the part of the bit sequence 500 corresponding to the first context including the second field, ‘b’. Thereafter, the consume operation (not shown) is called once more to reduce the count of the number of bits remaining to be decoded by the number of bits decoded corresponding to the “code for a”, the consume operation being performed on the topmost entry of the stack 200. Thus, the stack 200 is updated to:
<(a−b, n) (n−aₛ, n)>
<(0, n) (n−aₛ, n)>

After updating the topmost entry of the stack 200, the decoder process executes the call to the popz operation resulting in removal of the topmost entry of the stack 200 and updating the remaining, now topmost, entry of the stack 200 to reflect the number of bits remaining to be processed.

The remaining entry in the stack 200 is therefore:
<(0, n)>
   where n is the total length of the first packet, P1.

Turning to code fragment II, at runtime, the bit sequence 500 is read-in. In this example, the bit sequence 500 constitutes a second packet, P2, formed to conform with the second PDU type, T2. The stack 200 is formed with the initial entry in the same way as in the previous example:
<(n, n)>
   where n is the known size of the PDU to be decoded. The new operation is then called to add an entry to the top of the stack 200, thereby yielding an updated stack of:
<(n, n) (n, n)>.

Thereafter, the code for decoding the first sub-field, ‘a’, of the second packet, P2, is executed and the value of the first sub-field is established. The consume operation (not shown, but described above) is then called in order to account for the processing of the first sub-field, ‘a’, resulting in the stack 200 becoming:
<(n−aₛ, n) (n, n)>
   where aₛ constitutes the number of bits “consumed” by the processing of the first sub-field, ‘a’, namely the length of the first sub-field, ‘a’, in bits. Following execution of the consume operation, the set operation is called using the value of the first sub-field, ‘a’, to set the topmost entry of the stack 200, updating the stack 200 to:
<(a, n) (n, n)>

Next, the code associated with decoding the second sub-field, ‘b’, is executed. Upon execution of the code for decoding the second sub-field, ‘b’, the consume operation (not shown) is once-more called and the stack is modified to:
<(a−bₛ, n) (n, n)>=(0,n)(n,n)>
   where bₛ constitutes the number of bits “consumed” by the processing of the second sub-field, ‘b’, namely the length of the second sub-field, ‘b’, in bits. Thereafter, the popz operation is called to yield:
<(n−n, n)>
=(0,n)>

Turning to code fragment III, at runtime, the bit sequence 500 is read-in. In this example, the bit sequence 500 constitutes a third packet, P3, formed to conform with the third PDU type, T3. As described in the previous example, the stack 200 is formed with the initial entry:
<(n, n)>
   where n is the known size of the PDU to be decoded. The first new operation is then called to update the stack 200 to:
<(n, n) (n, n)>

The second new operation is then called to update the stack 200 further to:
<(n, n) (n, n) (n, n)>.

Thereafter, the code to decode the first sub-field, ‘x’, is executed followed by the call to the consume operation. The stack 200 therefore becomes:
<(n−xₛ, n) (n, n) (n, n)>
   where xₛ is the number of bits “consumed” in the processing of the first sub-field, x. The code to decode the second sub-field, ‘y’, is then executed followed by the call to the next consume operation, modifying the stack 200 to:
<(n−xₓ−yₛ, n) (n, n) (n, n)>
   where yₛ is the number of bits “consumed” in the processing of the second sub-field, ‘y’.

The set operation is then called, updating the topmost entry of the stack 200 to:
<(y+n−xₛ−yₛ−n, y) n, n))n, n)>
=<(y−xₛ−yₛ,y)(n,n)(n,n)>
   where y is the value of the second sub-field, ‘y’.

The code to decode the third sub-field, ‘z’, is then executed followed by the call to the consume operation, modifying the stack 200 to:
<(y−xₛ−yₛ−zₛ, y) (n, n) (n, n)>
=<(0, y) (n, n) (n, n)>
   where zₛ is the number of bits “consumed” in the processing of the third sub-field, ‘z’. Thereafter, the popz operation is called, modifying the stack 200 to:
<(n−y, n) (n, n)>

The set operation is then called to update the stack 200 to:
<(x+n−y−n, n) (n, n)>
=<(x−y, n) (n, n)>
   where x is the value of the first sub-field, ‘x’. The code to decode the second field, b, is then executed followed by a call to the consume operation, modifying the stack 200 to:
<(x−y−b, n) (n, n)>
=<(0, n) (n, n)>
   where b is the number of bits “consumed” in processing the second field, ‘b’. Thereafter, the popz operation is called, modifying the stack 200 to:
<(0, n)>

In the above examples, the overall lengths of the first, second and third packets, P1, P2, P3 were known. However, in circumstances where the length of a given PDU is not initially known, for example when the bit sequence 500 is being decoded “off the wire”, an arbitrary value for the length of the PDU is selected, which is known to be larger than the actual length of the PDU. After the above-described manipulation of the stack 200, the remaining entry in the stack 200<(m′, m)>enables the actual size of the protocol data to be calculated, where m is the arbitrarily set value for the size of the PDU and m′ is the calculated bits remaining. In such circumstances, the actual size of the PDU is: m−m′.

Whilst in the above examples, consume operations have been explicitly incorporated into the machine executable code 102, another implementation particularly applicable to virtual machine implementations is to combine an operation to process a number of bits with advancement of a buffer pointer, the buffer pointer tracking progress of decoding of the bit sequence 500.

Whilst the above examples are examples of stack manipulation under error-free conditions, the use of the above-described operations to create and update the stack 200 enables the length of a PDU to be tracked. In this respect, using the stack 200, the decode process is able to ensure that decoding instructions for a field consume no more or less bits than indicated by a constraint on the field. Where the overall length of the PDU is known ab initio, it is possible to reduce the overall number of checks on the length of the PDU during decoding of constituent fields of the PDU. As a result of implementing the operations described above, the operations ensure that no more bits than available can be consumed. In this respect, and referring to the stack operations previously defined, each stack operation has a side-condition associated therewith. In relation to some of the operations, the side condition is implicit for example the stack 200 has to have entries upon which the operation can be performed. In relation to the push operation, the number of bits that can be removed from a count of remaining bits cannot exceed the number of bits remaining to be processed. In relation to the popz operation, the operation is structured such that it ensures that exactly the correct number of bits are consumed when an exact bound is known. Consequently, when a non-zero positive, remainder exists after execution of a popz operation, the side-condition of the popz operation is breached. In this respect, if as a result of executing the popz operation, the first parameter of the remaining entry of the stack 200 is non-zero, for example <(x, n)> where x>0, then this is an indication that the first packet, P1, was improperly formed. Typically, an implementation of the packet decoder would terminate the decoding of the packet and report an error. The skilled person will appreciate that such functionality can be achieved in a number of ways. Other side-conditions exist, as described above in relation to the definitions of the stack operations. Where a side-condition of a stack operation is breached, this is indicative of a failure, for example improperly formed packets or packets modified in transit, and hence detection of erroneous packets. As mentioned above, such conditions are detected by the runtime environment supported by the processing resource 404 and an error or warning message can be generated.

Further, the new operation ensures that sizes are inherited in the stack from surrounding contexts and so ensures that the size of a buffer storing the bit sequence 500 cannot be exceeded without violating the side-condition of the consume operation and hence exposing the existence of a failure or error.

In some protocols, it is necessary to define a field having a size corresponding to the number of bits remaining in a current context. However, the calculations involving this field duplicate some of the steps carried out in relation to manipulation of the stack 200. It is therefore useful to include in the packet type specification language an attribute, for example, “bitsLeft”, to refer to the current value of the remainder at the top of the stack 200. The bitsLeft attribute can be supported by a remainder operation on the stack to retrieve this value, the operation being defined as:

remainder: s→n
remainder ((r, m)·σ)=r

The instruction simply returns the value of bits remaining according to the topmost entry of the stack.

Another optimisation, particularly for virtual machine implementations, decouples updating of the stack 200 from updating of a buffer pointer instead of performing both operations in response to a single instruction. Such decoupling enables consume operations to be grouped together and hence combined into a single consume operation in a like manner to that already described above. Once verification of availability of remaining bits has been performed, the bits to be processed are processed with a consequential update of the buffer pointer. In practice, such an approach reduces the number of executions of the consume operation and verification of associated side-conditions to a single execution and verification.

Although the above embodiments have been described, in parts, in the context of packet communications, it should be appreciated that the term “packet” can refer to a PDU that can be used in relation to the above embodiments and vice versa. Further, other types of PDUs can be employed, for example: datagrams, frames, and cells and so these terms should be understood to be interchangeable.

Although in the above embodiments mention has been made of the IPv4, the skilled person will appreciate that the above described techniques can be applied in the context of other communications protocols.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A method of decoding a bit sequence, the method comprising:
reading-in the bit sequence corresponding to a PDU;
processing the bit sequence;
during the processing of the bit sequence, using a data stack to maintain a record of a quantity of bits remaining to be processed.

2. A method as claimed in claim 1, wherein processing the bit sequence comprises decoding the bit sequence.

3. A method as claimed in claim 2, wherein the PDU conforms to a predefined data type definition, the bit sequence being decoded in accordance with the predefined data type definition.

4. A method as claimed in claim 3, wherein the PDU comprises a first field having a first length defined by the data type definition.

5. A method as claimed in claim 3, wherein the PDU comprises a second field having a second length defined by the data type definition.

6. A method as claimed in claim 5, wherein the second field is disposed within the first field.

7. A method as claimed in claim 5, wherein the first length of the first field is dependent upon the second length of the second field.

8. A method as claimed in claim 1, further comprising:
decoding a number of bits of the bit sequence to obtain size constraint data; and
manipulating the data stack in response to obtaining the size constraint data.

9. A method as claimed in claim 1, wherein the data stack is manipulated with respect of a topmost entry thereof.

10. A method as claimed in claim 9, wherein the topmost entry of the data stack is manipulated to the exclusion of other entries in the data stack below the topmost entry.

11. A method as claimed in claim 1, wherein relative positions in the data stack signify relative positions of fields in the PDU.

12. A method as claimed in claim 1, further comprising manipulating the data stack by execution of an operation in relation to the data stack.

13. A method as claimed in claim 8, wherein manipulation of the data stack has a side-condition associated therewith, breach of the side-condition being indicative of an error and/or fault.

14. A network element apparatus comprising:
an input for reading-in, when in use, a bit sequence corresponding to a PDU;
a decoder unit coupled to the input, the decoder unit being arranged to process the bit sequence; wherein
the decoder unit is further arranged to use during the processing of the bit sequence, a data stack to maintain a record of a quantity of bits remaining to be processed.

15. A PDU specification language toolkit comprising:
a library of operations in order to maintain a data stack having a data entry relating to a constraint of a field for a PDU;
a compiler arranged to use the library of operations in order to compile, when in use, code expressed in an implementation language into object code constituting a PDU decoder for execution by a network element; wherein an operation of the library of operations is executable, when in use, so as to manipulate the data stack during decoding of a bit sequence in order to maintain a record of a quantity of bits of the bit sequence remaining to be processed.

16. A toolkit as claimed in claim 14, wherein the operation is arranged to add a data entry to the data stack.

17. A toolkit as claimed in claim 14, wherein the operation is arranged to remove a data entry from the data stack.

18. A toolkit as claimed in claim 14, wherein the operation is arranged to modify a data entry of the data stack.

19. A computer program element embodied on a computer readable medium, comprising computer program code means to make a computer execute the method as claimed in claim 1.

20-23. (canceled)
